(19) United States
(12) Patent Application Publication
(10) Pub. No.: US 2024/0240723 A1
(43) Pub. Date: Jul. 18, 2024

(54) Thermostatic valve set and valve assembly containing the same

(71) Applicant: Globe Union Industrial Corp., Taichung City (TW)

(72) Inventors: Yuan-Hao Chang, Taichung City (TW); Chia-Hua Yuan, Taichung City (TW)

(21) Appl. No.: 18/529,118

(22) Filed: Dec. 5, 2023

(30) Foreign Application Priority Data
Jan. 16, 2023 (TW) 112200565

(51) Int. Cl. F16K 11/00

(52) U.S. Cl. CPC F16K 19/006

(57) ABSTRACT

A thermostatic valve set and a valve assembly containing the same are provided. The thermostatic valve set includes a thermostatic valve and an adapter, both able to switch between a first assembled state and a second assembled state and assembled. The valve assembly includes a seat for mounting the thermostatic valve set and a valve cap for fastening the thermostatic valve set to the seat. The adapter is mounted in a mounting groove of the seat in an oriented manner. When the thermostatic valve set is installed in the second assembled state, it can be positioned on a seat with reversed cold-water and hot-water supplies. The reversed condition is corrected and the thermostatic valve can work well. By the above thermostatic valve set, the valve assemblies are installed back-to-back without modification or rearrangement of the hot-water and the cold-water supply pipelines. Thereby installation time and cost are reduced.

### BACKGROUND OF THE INVENTION

The present invention relates to a valve assembly, especially to a concealed or in-wall thermostatic valve set and a valve assembly containing the same.

### PRIOR ART

Generally, a valve assembly with thermostatic function has been widely used in shower facilities. The valve assembly is often installed behind the wall or in a concealed manner. A typical valve assembly includes a valve seat, a thermostatic valve mounted to the valve seat, and a valve cap used for fastening the thermostatic valve to the valve seat. The valve seat is installed behind a wall and connected with preset cold-water and hot-water supply pipelines. Thus water from hot and cold water sources outside flows into the valve seat through the cold-water and the hot-water supply pipelines. A part of the thermostatic valve is inserted through the wall and projecting from an outer surface of the wall. Thereby a shaft of the thermostatic valve can be driven and rotated by wrench assembly for outside installation to adjust on/off and a mixing ratio of cold and hot water. A temperature of mixing water output from the valve seat is further controlled. The valve seat usually includes an upper mixing water outlet and a lower mixing water outlet, which are respectively connected to an upper output device (such as shower head) and a lower output device by (such as faucet) a mixing water output pipeline and another mixing water output pipeline. Thus water is released for shower or coming out from the faucet. The above thermostatic valve can be either a temperature-sensing thermostatic valve or a pressure-balance thermostatic valve. By extension of a temperature detector or temperature sensor generated during detection of sensing of temperature of the mixed water, sizes of connection holes which allow cold water and hot water to flow through are adjusted automatically for control of temperature and maintaining at a constant temperature. The valve assembly or thermostatic valve with the same or similar structure as the above one has been revealed in many prior arts including Chinese Patent Publication No. CN216789311U, CN212690902U, CN203296118U, CN212690900U, CN210050326U, etc.

In some families or public place such as two adjacent bathrooms or shower rooms, the shower facilities are often mounted to a common wall therebetween. That means the two concealed or in-wall valve assemblies are installed on the common wall in a back-to-back manner. However, cold water and hot water supply pipelines are usually preset inside the common wall. The cold water supply pipeline and the hot water supply pipeline are respectively reserved on the left side and the right side of the valve assembly. It is well-known that a cold-water side of the valve assembly for input of cold water is on the right side of the front surface of the valve assembly, or the right side from user's view while a hot-water side of the valve assembly for input of hot water is on the left side of the front surface of the valve assembly, or the left side from user's view. Thereby one of the valve assemblies can be installed directly once its cold-water side on the right side of the valve assembly is just aligned with the cold water supply pipeline. In contrast, the cold-water side on the right side of the other valve assembly would be aligned with the hot water supply pipeline so that hot and cold water are reversed. Once the valve seat and the thermostatic valve are installed in such way, water flowing into a cold water inlet of the thermostatic valve is hot water and water flowing into a hot water inlet of the thermostatic valve is cold water at last. Limited by pipelines and thermostatic structure inside the thermostatic valve, the reversed hot and cold water will lead to a malfunction of thermostatic control of the thermostatic valve and further the temperature control function. Thus the cold water and hot water supply pipelines available now need to be modified or rearranged. A cold water supply pipeline and a hot water supply pipeline respectively coming from a cold water source and a hot water source are divided into two cold water supply pipes and two cold water supply pipes. One of the cold water supply pipes and one of the hot water supply pipes are modified and rearranged to another side by connection with new pipelines. Such modification and arrangement are usually performed on site according to actual conditions. This not only increases installation time and cost but also raises difficulty of overall operation, and even keeps installers at bay. Thus there is room for improvement and there is a need to provide a novel thermostatic valve set and a valve assembly containing the same which can solve the above problems of the back-to-back installation.

### SUMMARY OF THE INVENTION

Therefore, it is a primary object of the present invention to provide a thermostatic valve set and a valve assembly containing the same. The thermostatic valve set includes a thermostatic valve and an adapter which are having a central angle of 180 degrees therebetween and able to be shifted between a first assembled state and a second assembled state and assembled. The valve assembly includes a seat for mounting the thermostatic valve set and a valve cap for fastening the thermostatic valve set to the seat. The adapter is mounted and positioned in a mounting groove of the seat in an oriented manner. When the thermostatic valve set is assembled and positioned in the second assembled state, it can be installed and positioned on a seat with reversed cold-water and hot-water supplies. Thereby the reversed condition is corrected and the thermostatic valve can operate normally.

It is another object of the present invention to provide a thermostatic valve set and a valve assembly containing the same. The thermostatic valve set includes a thermostatic valve and an adapter which are able to be rotated 180 degrees with respect to each other for switching between a first assembled state and a second assembled state. The thermostatic valve set with the above design can be applied to back-to-back installation of the valve assemblies, without modification or rearrangement of the cold-water and hot-water supplies. Thereby installation time and cost for modification and rearrangement of the cold-water and hot-water supplies can be saved and installation of the valve assemblies is easy and quick.

### BRIEF DESCRIPTION OF THE FIGURES

FIG. 1 is a perspective view of an embodiment of a thermostatic valve set according to the present invention;

FIG. 2 is a bottom view of an embodiment of a thermostatic valve set according to the present invention;

FIG. 3 is a sectional view along line A-A of the embodiment shown in FIG. 2 according to the present invention;

FIG. 4 is a sectional view along line B-B of the embodiment shown in FIG. 2 according to the present invention;

FIG. 5 is an exploded view of an embodiment of a thermostatic valve set according to the present invention;

FIG. 6 is a partial exploded view of an embodiment of a thermostatic valve set according to the present invention;

FIG. 7 is a partial perspective view of an embodiment of a thermostatic valve set according to the present invention;

FIG. 8 is a perspective view of an embodiment of a valve assembly according to the present invention;

FIG. 9 is an exploded view of an embodiment of a valve assembly showing main components according to the present invention;

FIG. 10 is a cross sectional view of an embodiment of a valve assembly according to the present invention;

FIG. 11 is a longitudinal sectional view of an embodiment of a valve assembly according to the present invention;

FIG. 12 is a rear exploded view of an embodiment of a seat according to the present invention;

FIG. 13 is a schematic drawing showing an arrangement of a first valve assembly and a second valve assembly in a back-to-back manner of an embodiment according to the present invention;

FIG. 14 is a schematic drawing showing another arrangement of a first valve assembly and a second valve assembly in a back-to-back manner of an embodiment according to the present invention;

FIG. 15 is a cross sectional view showing a first valve assembly and a second valve assembly assembled on a common wall in a back-to-back manner of an embodiment according to the present invention;

### DETAILED DESCRIPTION OF CERTAIN EMBODIMENTS

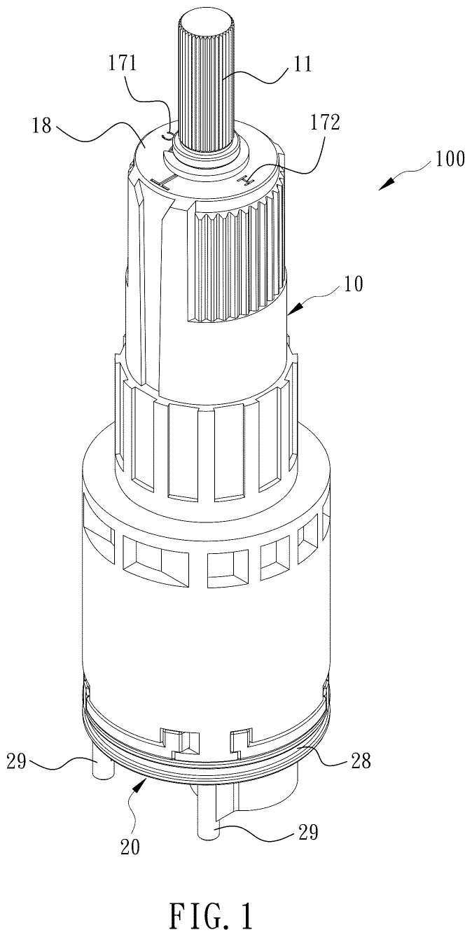

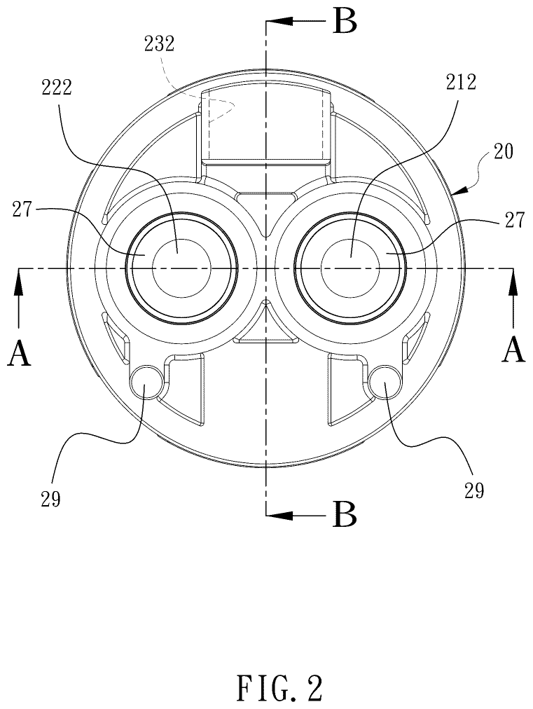

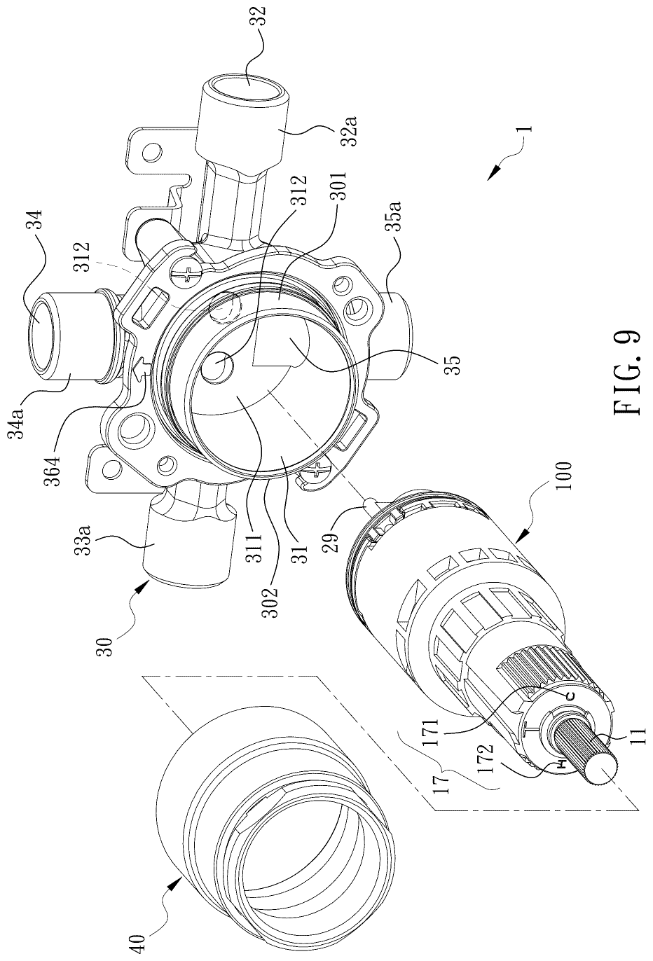

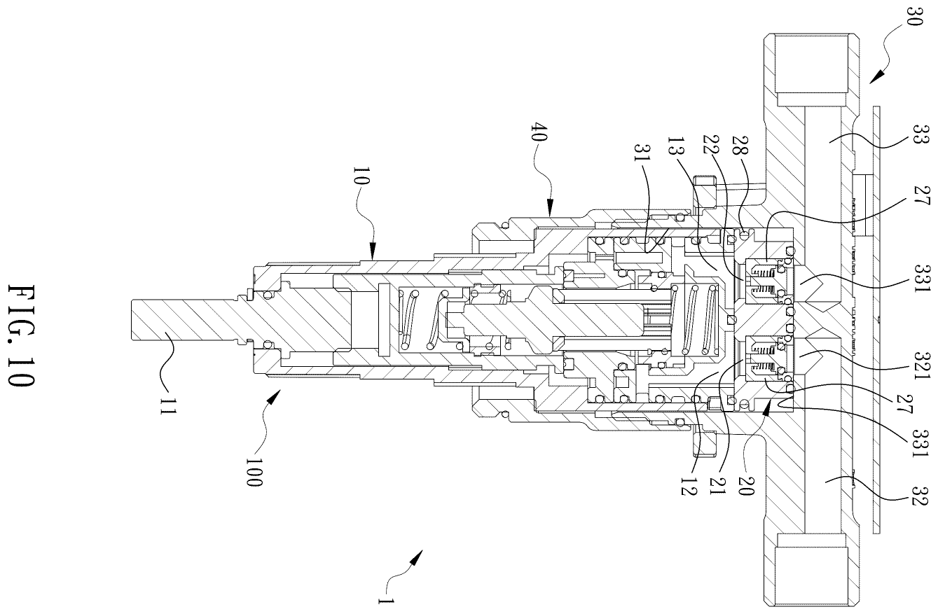

As shown in FIG. 1-6, a thermostatic valve set 100 according to the present invention includes a thermostatic valve 10 and an adapter 20. The thermostatic valve set 100 is installed on a seat 30, as shown in FIG. 8 and FIG. 9.

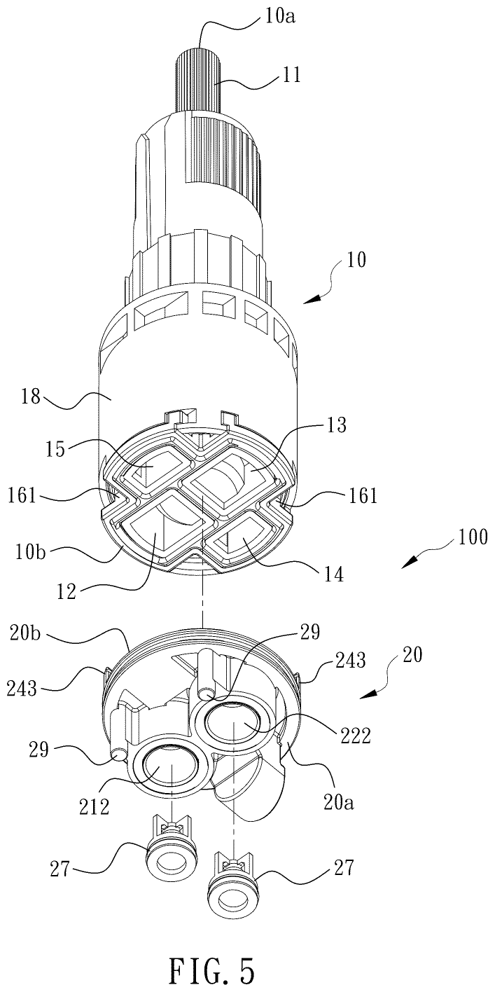

As shown in FIG. 5, the thermostatic valve 10 consists of an operation end 10a and a water end 10b. The operation end 10a is provided with a shaft 11 which is rotating adjustable while the water end 10b is composed of a cold-water inlet 12, a hot-water inlet 13, a first mixed water outlet 14, and a second mixed water outlet 15. The first mixed water outlet 14 and the second mixed water outlet 15 are arranged with a 180-degree between them.

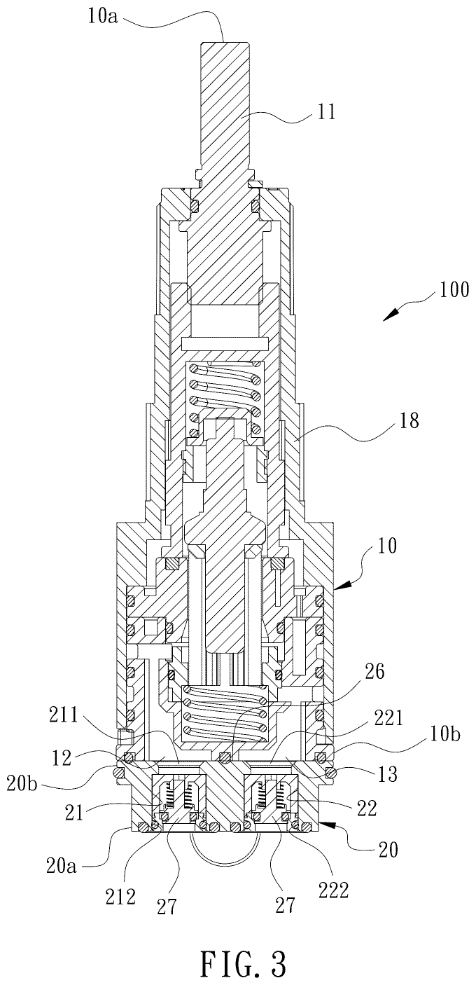

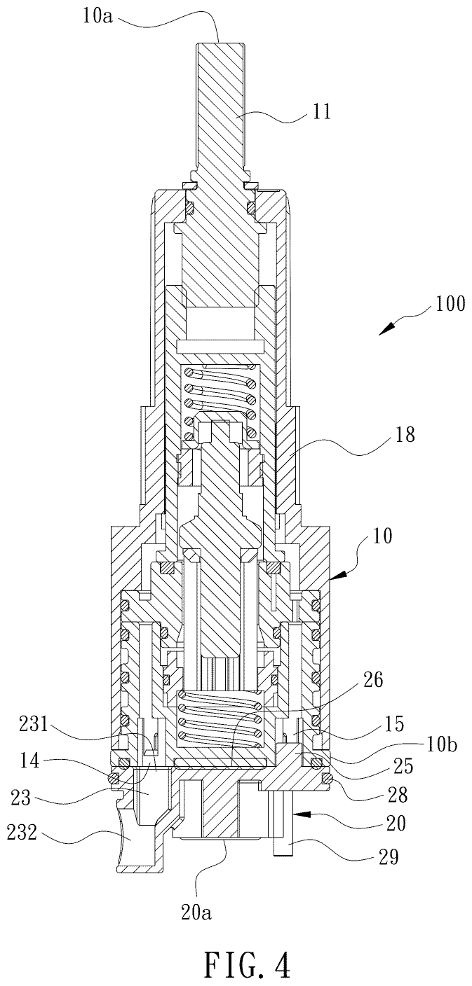

The adapter 20 is provided with an installation side 20a and an adaption side 20b. The adaption side 20b is detachably connected with the water end 10b of the thermostatic valve 10. As shown in FIG. 3 and FIG. 4, the adapter 20 includes a cold-water inlet channel 21, a hot-water inlet channel 22, and a mixing-water outlet channel 23 which respectively form a cold-water port 211, a hot-water port 221, and a mixing-water port 231 on the adaption side 20b. The cold-water port 211, the hot-water port 221, and the mixing-water port 231 are respectively connected and communicating with the cold-water inlet 12, the hot-water inlet 13, and the first mixed water outlet 14 to be in a first assembled state. The thermostatic valve 10 is allowed to be rotated 180 degrees after being detached from the adapter 20 and then reassembled with the adapter 20 to be in a second assembled state. In the second assembled state, the cold-water port 2111, the hot-water port 221, and the mixing-water port 231 are respectively connected and communicating with the hot-water inlet 13, the cold-water inlet 12, and the second mixed water outlet 15 correspondingly.

In this embodiment, the thermostatic valve 10 is a temperature-sensing thermostatic valve. The thermostatic valve 10 can be either a temperature-sensing thermostatic valve or a pressure-balance thermostatic valve.

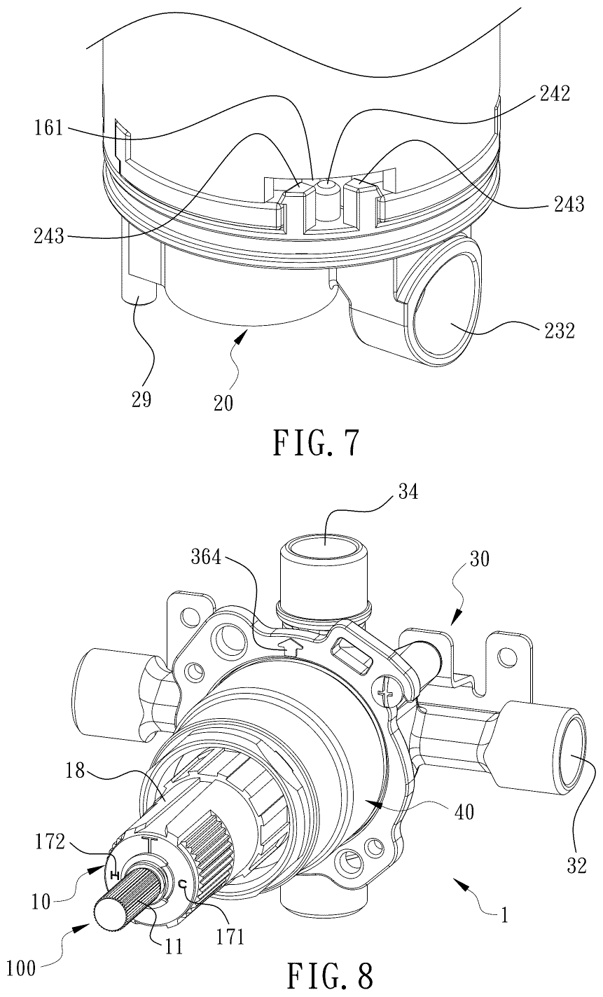

As shown in FIG. 5-7, the water end 10b of the thermostatic valve 10 is provided with a first positioning member 16 while the adaption side 20b of the adapter 20 is provided with a second positioning member 24. No matter in the first assembled state or the second assembled state, the thermostatic valve 10 and the adapter 20 are detachably assembled and positioned with each other by the first positioning member 16 and the second positioning member 24.

In this embodiment, the first positioning member 16 includes two positioning grooves 161 with a 180-degree angle between them while the second positioning member 24 includes two positioning protrusions 241 having a 180-degree angle therebetween and able to be detachably assembled and positioned with the corresponding positioning grooves 161.

In this embodiment, the first positioning member 16 further includes four locking walls 162 disposed on two sides of the positioning grooves 161. Each of the positioning protrusions 241 includes a positioning pin 242 and two elastic locking blocks 243. An outer peripheral wall of the positioning pin 242 is able to abut against and position in an inner wall of the corresponding positioning groove 161 circumferentially. The elastic locking block 243 is detachably locked on and limited by the locking wall 162 of the corresponding positioning groove 161.

It should be noted that the design of the positioning pins 242 abutting against the respective positioning grooves 161 correspondingly prevents the thermostatic valve 10 and the adapter 20 from rotating with respect to each other circumferentially, or wobbling radially. By the design of the elastic locking block 243 elastically locked on the corresponding locking wall 162, it is ensured that the adapter 20 is temporarily fixed on the water end 10b, or fixed on the water end 10b on the bottom of the thermostatic valve 10 with low holding strength. The benefit of the above design is that the thermostatic valve 10 and the adapter 20 will not be in a loose state and this helps packaging and the following assembly and positioning on the seat 30. Moreover, users only need to apply a bit force, the thermostatic valve 10 and the adapter 20 are detached and separated from each other axially. The above design helps them change from the first assembled state to the second assembled state.

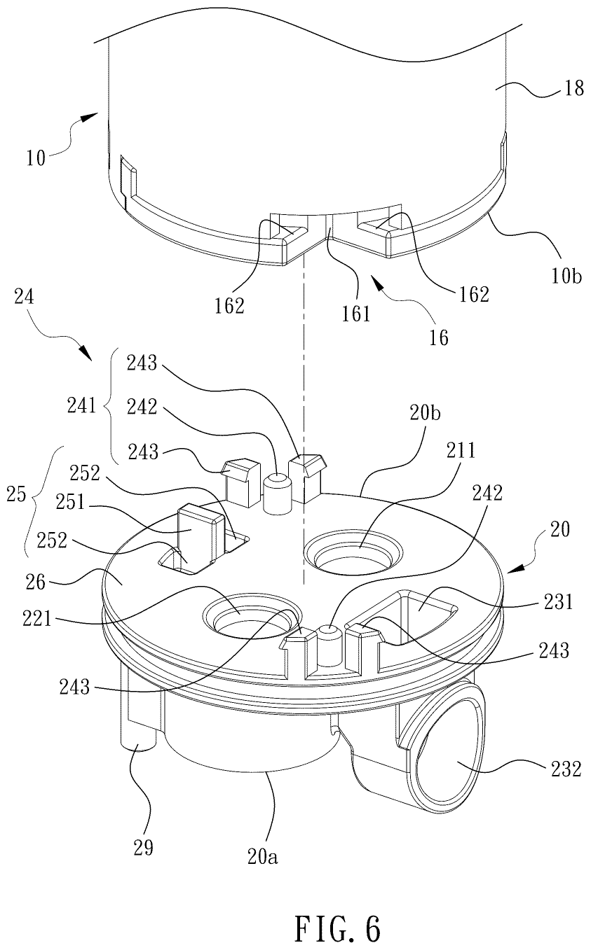

As shown in FIG. 6, in this embodiment, the adaption side 20b of the adapter 20 is further provided with a clipped portion 25 which can be clipped by tools to remove the adapter 20.

More specifically, the adaption side 20b of the adapter 20 is provided with a junction surface 26 on which the cold-water port 211, the hot-water port 221, and the mixing-water port 231 are formed. The clipped portion 25 is disposed on the junction surface 26 at a position having a 180-degree angle with respect to the mixing-water port 231. The clipped portion 25 is formed by one protruding block 251 projecting from the junction surface 26 and two relief grooves 252 recessed from the junction surface 26 and located adjacent to two sides of the protruding block 251. The protruding block 251 is used for holding and able to be inserted into one of the first mixed water outlet 14 and the second mixed water outlet 15 which are located on the water end 10b of the thermostatic valve 10 and opposite to each other, as shown in FIG. 4.

It can be understood easily that the protruding block 251 can be held directly by general tools, specific tools, or fingers to take the adapter 20 out from the seat 30. The design of the relief grooves 252 provides more space allowing the above tools or fingers to be mounted therein for holding the protruding block 251 smoothly. Thereby a height of the protruding block 251 projecting from the junction surface 26 can be shortened.

In this embodiment, as shown in FIG. 3 and FIG. 5, both the cold-water inlet channel 21 and the hot-water inlet channel 22 of the adapter 2 are provided with a check valve 27 through the installation side 20a. The installation and limitation of the check valve 27 prevents backflow of cold water or hot water flowing from the seat 30 to the thermostatic valve 10 through the corresponding cold-water inlet channel 21 and the hot-water inlet channel 22 of the adapter 20 and further protects cold-water or hot-water water source from contamination.

In this embodiment, as shown in FIG. 10, a waterproof gasket 28 is mounted and positioned on a peripheral wall of the adapter 20 to ensure that the adapter 20 is mounted in the seat 30 in a watertight manner.

In this embodiment, as shown in FIG. 3 and FIG. 4, the cold-water inlet channel 21, the hot-water inlet channel 22, and the mixing-water outlet channel 23 of the adapter 20 are respectively forming a cold-water supply outlet 212, a hot-water supply outlet 222, and a mixing-water supply outlet 232 at the installation side 20a. The hot-water port 221 and the hot-water supply outlet 222 are disposed on the same axis while directions of the mixing-water port 231 and the mixing-water supply outlet 232 are perpendicular to each other.

In this embodiment, as shown in FIG. 9, two positioning posts 29 are mounted on the installation side 20a of the adapter 20 for allowing the adapter 20 to be oriented and mounted in the seat 30.

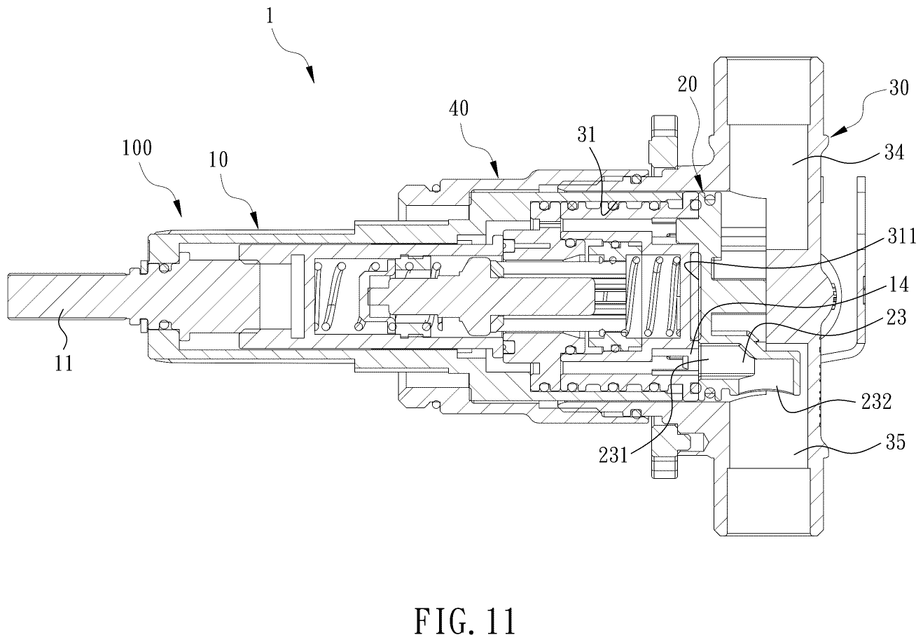

As shown in FIG. 8-11, an embodiment of a valve assembly 1 according to the present invention is provided. The valve assembly 1 includes the thermostatic valve set 100 a seat 30, and a valve cap 40. The seat 30 consists of a mounting groove 31, a cold-water supply channel 32, a hot-water supply channel 33, a first mixed water supply channel 34, and a second mixed water supply channel 35. The cold-water supply channel 32, the hot-water supply channel 33, the first mixed water supply channel 34, and the second mixed water supply channel 35 are all communicating with the mounting groove 31. The mounting groove 31 is used for mounting and positioning the installation side 20a of the adapter 20 of the thermostatic valve set 100 therein and provided with an installation wall 311 on a bottom thereof. The cold-water supply channel 32 and the hot-water supply channel 33 are respectively provided with a cold-water intake opening 321 and a hot-water intake opening 331 which are located on the installation wall 311 and respectively communicating with the cold-water inlet channel 21 and the hot-water inlet channel 22 of the adapter 20. The first mixed water supply channel 34 and the second mixed water supply channel 35 are communicating with the mixing-water outlet channel 23 of the adapter 20 at the same time. The valve cap 40 is threaded and fastened on the seat 30 so that the thermostatic valve set 100 is compressed and fixed on the seat 30.

As shown in FIG. 9, in this embodiment, the thermostatic valve 10 is provided with a first assembly marker 17 used for recognition of installation directions while mounting the thermostatic valve set 100 in the mounting groove 31 of the seat 30.

More specifically, the thermostatic valve 10 further includes a valve housing 18 from which the shaft 11 is protruding. A cold-water side marker 171 and a hot-water side marker 172 are disposed on the valve housing 18, located at two opposite sides of the shaft 11 and combined to form the first assembly marker 17. After the seat 30 being fixed and both the thermostatic valve 10 and the adapter 20 in the first assembled state, as shown in FIG. 9, the thermostatic valve set 100 is assembled by the cold-water side marker 171 and the hot-water side marker 172 respectively being aligned with a first side 301 and a second side 302 of the seat 30. When the thermostatic valve 10 and the adapter 20 are in the second assembled state, the thermostatic valve set 100 is assembled by the cold-water side marker 171 and the hot-water side marker 172 respectively being aligned with the second side 302 and the first side 301 of the seat 30.

In this embodiment, based on people's habits in use and installation, the cold-water side marker 171 is letter C which is the first letter of the word “COLD” and used for representing the cold water side while the hot-water side marker 172 is letter H which is the first letter of the word “HOT” and used for representing the hot water side. Viewed from the user facing the valve assembly 1, the first side 301 is at the right side of the seat 30. Under normal conditions, the right side of the seat 30 is a cold-water supply side. Under specific conditions, the right side of the seat 30 is a hot-water supply side. The second side 302 is at the left side of the seat 30. Under normal conditions, the left side of the seat 30 is the hot-water supply side. Under specific conditions, the left side of the seat 30 is the cold-water supply side.

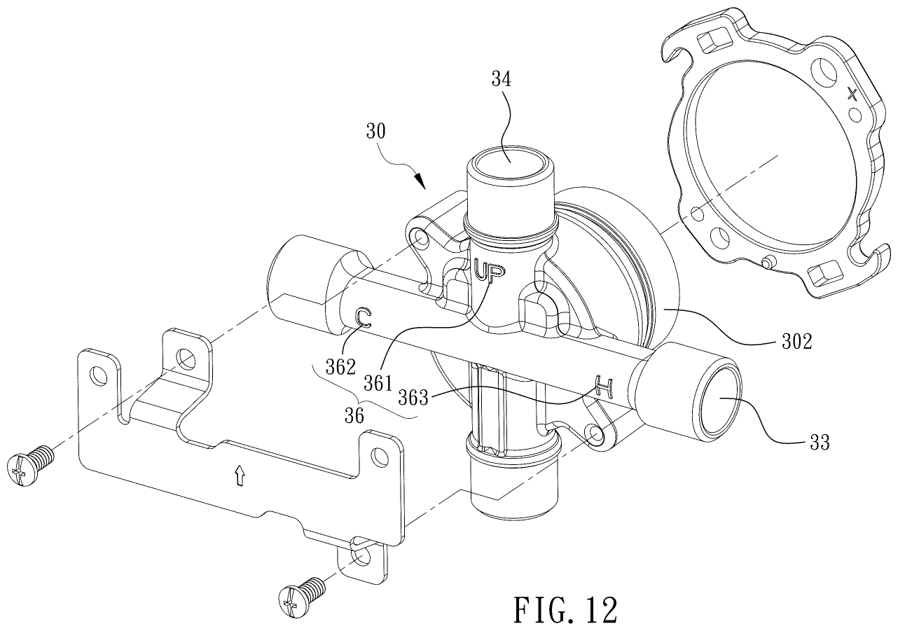

In this embodiment, as shown in FIG. 12, the seat 30 includes a second assembly marker 36 which is disposed on another side of the seat 30 opposite to one side of the seat 30 with the mounting groove 31, the back side of the seat 30. The second assembly marker 36 is used for recognition of installation directions while mounting and fixing the seat 30.

More specifically, the second assembly marker 36 includes an upper marker 361, a cold-water marker 362, and a hot-water marker 363 which are all arranged at the side opposite to the side with the mounting groove 31. When the thermostatic valve 10 and the adapter 20 are in the first assembled state, the cold-water side marker 171 of the first assembly marker 17 and the cold-water marker 362 of the second assembly marker 36 are on the same side as the first side 301 of the seat 30 and also the same side as the cold-water supply side. When the thermostatic valve 10 and the adapter 20 are in the second assembled state, the cold-water side marker 171 of the first assembly marker 17 and the hot-water marker 363 of the second assembly marker 36 are on the same side as the second side 302 of the seat 30 but still the same as the cold-water supply side. This is due to that the seat 30 is installed under the specific condition. One side of the seat 30 with respect to the hot-water marker 363 in fact is the cold-water supply side, not the hot-water supply side.

In this embodiment, the second assembly marker 36 further includes an upper-side marker 364 disposed on the side of the seat 30 with the mounting groove 31, such as an upward arrow pointing upward (as shown in FIG. 9).

In this embodiment, as shown in FIG. 9, the seat 30 further includes a cold-water connector 32a on one side thereof corresponding to the cold-water supply channel 32 for connection with a cold-water supply pipeline, a hot-water connector 33a on another side thereof with respect to the hot-water supply channel 33 for connection with a hot-water supply pipeline, a first mixed water connector 34a on an upper side thereof provided with the first mixed water supply channel 34 for connection with an upper water outlet device such as a shower head, and a second mixed water connector 35a on a lower side thereof corresponding to the second mixed water supply channel 35 for connection with a lower water outlet device such as a faucet.

Refer to FIG. 12, the upper marker 361 on the back side of the seat 30 is word “UP” representing the upper side and disposed correspondingly to the first mixed water connector 34a. That means the seat 30 must be installed under the condition that the first mixed water connector 34a is on the upper side. The cold-water marker 362 is also the letter C representing the cold water side. Viewed from the back side of the seat 30, it (letter C) is set on the left side. While viewed from the user side, it's set on the right side. Similarly, the hot-water marker 363 is the letter H representing the hot water side. An installation direction of the hot-water marker 363 is opposite to the cold-water marker 362, left and right reversed. Moreover, the upper-side marker 364 on a front side of the seat 30 is an upward arrow so that installation personnel can get useful information at the front side of the seat 30. By the design of the second assembly marker 36 which provides the installation personnel clear instructions and guidance, the seat 30 can be installed accurately and the following proper installation of the thermostatic valve set 100 is further ensured.

In this embodiment, as shown in FIG. 5 and FIG. 9, the installation wall 311 of the seat 30 is further provided with two positioning holes 312 through which the positioning posts 29 of the adapter 20 are inserted and positioned for orientation and mounting of the adapter 20 in the seat 30.

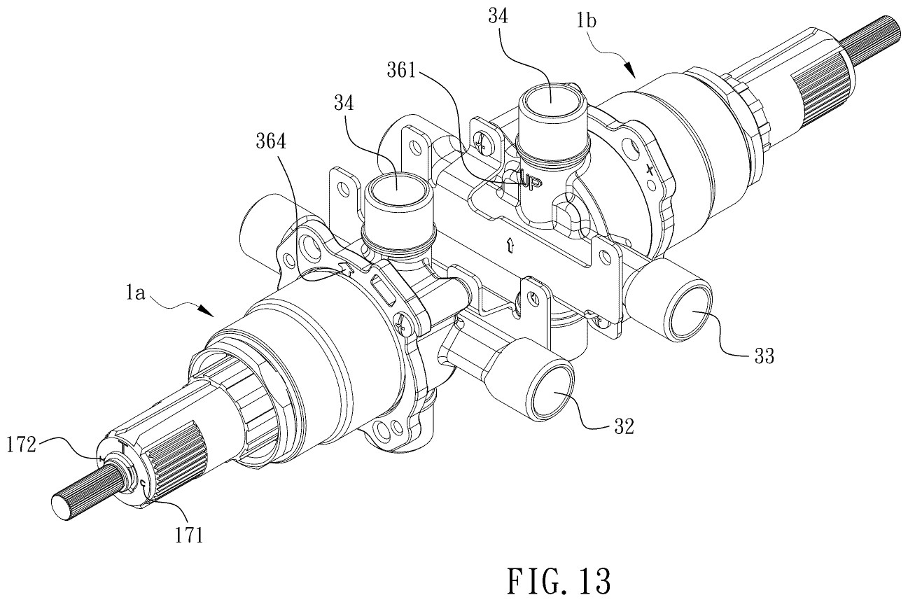

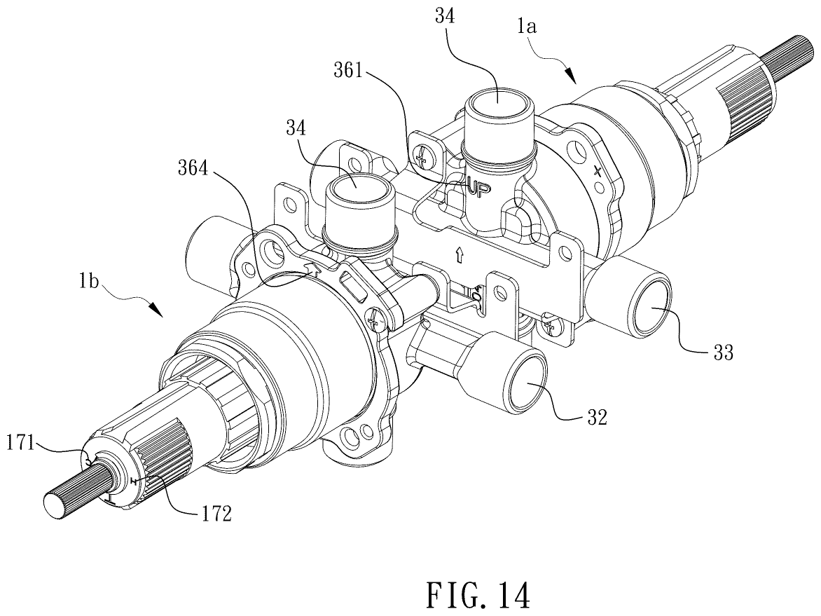

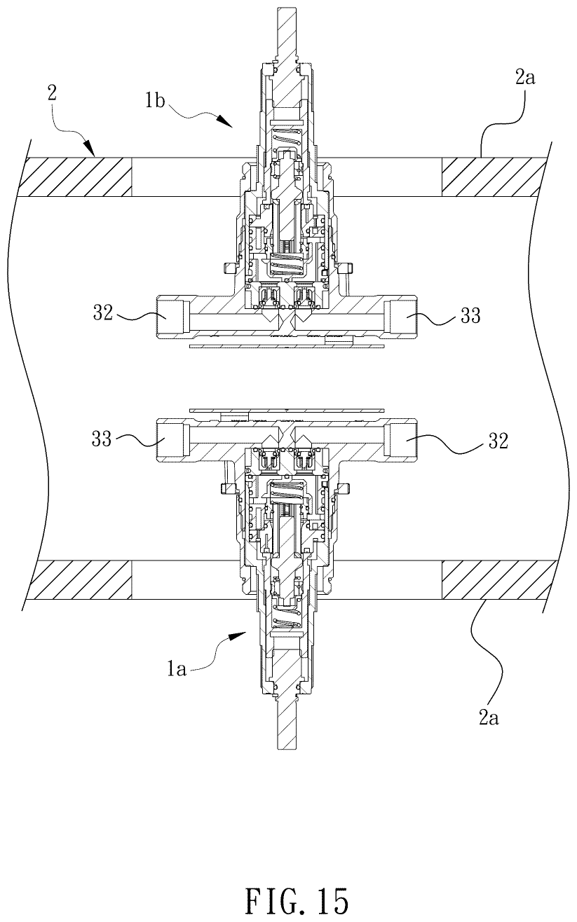

It should be noted that as shown in FIG. 13-15, the valve assembly 1 is suitable for back-to-back installation. One of the two valve assemblies 1 is installed in the normal way under instructions and guidance of the second assembly marker 36 but the other one is allowed to be installed in reverse. There is no need to modify or rearrange the cold-water supply pipeline and the hot-water supply pipeline. That means the two cold-water supply pipelines coming from one cold-water supply pipe and having the same cold-water supply source are located at the same side to supply cold water to the two valve assemblies 1. Similarly, the two hot-water supply pipelines coming from one hot-water supply pipe and having the same hot-water supply source are located at the same side (another side) to supply hot water to the two valve assemblies 1. The modification or rearrangement of the pipelines can be omitted so that time and cost required for assembling the valve assemblies 1 are significantly reduced.

To go a step further, the thermostatic valve set 100 and the valve assembly 1 containing the same are especially suitable for back-to-back installation. That means the two valve assemblies 1 are mounted to two opposite wall surfaces 2a of a common wall 2 in a back-to-back manner. In order to distinguish one from the other, the two valve assemblies 1 are labelled as the first valve assembly 1a and the second valve assembly 1b. Under normal conditions and viewed from the user, the cold-water supply pipeline is located on the right side of the first valve assembly 1a and the hot-water supply pipeline is located on the left side of the first valve assembly 1a during installation of the first valve assembly 1a. Thus the first valve assembly 1a can be installed in a normal way. That means the seat 30 of the first valve assembly 1a is assembled normally and the thermostatic valve 10 and the adapter 20 of the thermostatic valve set 100 are also assembled normally in the first assembled state. The thermostatic valve set 100 is usually pre-assembled and delivered in the first assembled state so that users can directly install and position the thermostatic valve set 100 on the seat 30 quickly under instructions and guidance of the first assembly marker 17 and then fasten with the valve cap 40 to complete the installation of the first valve assembly 1a. Under such normal installation, users can install the seat 30 and the thermostatic valve set 100 respectively according to the second assembly marker 36 and the first assembly marker 17.

More particularly, while assembling the second valve assembly 1b, the col-water supply pipeline must be located at the left side of the second valve assembly 1b and the seat 30 is installed with respect to the second assembly marker 36 with left and right reversed due to use of the common wall 2 and no modification or rearrangement of the cold-water supply pipeline and hot-water supply pipeline. In fact, water flows into the cold-water supply channel 32 of the seat 30 is hot water coming from the hot-water supply pipeline while water flows into the hot-water supply channel 33 of the seat 30 is cold water coming from the cold-water supply pipeline. Once the thermostatic valve 10 and the adapter 20 of the thermostatic valve set 100 are installed in the first assembled state, the cold water from the seat 30 flows into the hot-water inlet 13 of the thermostatic valve 10 while the hot water from the seat 30 flow into the cold-water inlet 12 of the thermostatic valve 10. According to design of internal channels and thermostatic parts in the present thermostatic valve 10 and thermostatic valves available now, the thermostatic valve 10 is unable to work normally and maintain a constant temperature.

In order to solve the above problem derived due to installation of the seat 30 under specific conditions, installation personnel can separate the thermostatic valve 10 and the adapter 20 from each other, rotate 180 degrees, and assemble again. Thereby they are in the above second assembled state, the specific condition. At the moment, water flow comes from the right side of the seat 30 with the cold-water marker 362 is hot water in fact while water flow comes from the left side of the seat 30 with the hot-water marker 363 is actually cold water. The adapter 20 of this embodiment is designed to be mounted in the mounting groove 31 of the seat 30 in an oriented manner. Thereby during installation of the thermostatic valve set 100, the cold-water side marker 171 on the thermostatic valve 10 is aligned with the hot-water marker 363 of the seat 30 after rotation of 180 degrees. That means the cold-water side marker 171 is aligned with the second side 302 on the left side of the seat 30. Thus the cold water coming from the seat 30 with the hot-water marker 363 can just flow into the cold-water inlet 12 at one side of the thermostatic valve 10 with the cold-water side marker 171. It should be understood easily that the hot-water side marker 172 on the thermostatic valve 10 is aligned with the cold-water marker 362 of the seat 30 after rotation of 180 degrees. That means the hot-water side marker 172 is aligned with the first side 301 on the right side of the seat 30. Thus the hot water coming from the seat 30 with the cold-water marker 362 can just flow into the hot-water inlet 13 at one side of the thermostatic valve 10 with the hot-water side marker 172. At the same time, it is also ensured that the adapter 20 is orientated and mounted into the seat 30 smoothly. By the structure design and specific installation way mentioned above, the hot water and the cold water flowing into the seat 30 and misplaced can still flow into the cold-water inlet 12 and the hot-water inlet 13 of the thermostatic valve 10 connected and aligned smoothly and accurately. Thereby normal operation of the thermostatic valve 10 is ensured.

According to the above embodiment, it is learned that the thermostatic valve set 100 and the valve assembly 1 containing the same according to the present invention have the following features and advantages.

Firstly, the two valve assemblies 1 are installed in a back-to-back manner without modification or rearrangement of the hot-water and the cold-water supply pipelines. By the design of the thermostatic valve 10 and the adapter 20 of the thermostatic valve set 100 which are rotated 180 degrees for switching between the first assembled state and the second assembled state to change assembly way, the two seats 30 are directly installed on the common wall 2 in a back-to-back manner without modification or rearrangement of the hot-water and the cold-water supply pipelines. Yet now hot-water and cold-water supplies of one of the seats 30 are reversed. The reversed condition can just be corrected by use of the thermostatic valve set 100 in the second assembled state. The hot and cold water supplies return to the normal conditions and normal operation of the thermostatic valve 10 is ensured. There is no need to modify or rearrange the cold and hot water supply pipelines so that time required for modification of pipelines is saved and operation cost is also reduced. Easiness of the following installation of the two valve assemblies 1 is further ensured.

Moreover, the thermostatic valve 10 and the adapter 20 are easy to install and position. The thermostatic valve 10 and the adapter 20 can be not only assembled and positioned with each other but also switched between the first assembled state and the second assembled state easily by the first positioning member 16 and the second positioning member 24. The first and second positioning members 16, 24 even provide temporarily fixing function so that the thermostatic valve 10 and the adapter 20 will not be in a loose state and this helps packaging and the following assembly on the seat 30.

The adapter 20 can be easily detached from the thermostatic valve 10. The adapter 20 can still be easily clipped and removed by the design of the clipped portion 25 while being retained in the mounting groove 31 of the seat 30 by the design of the positioning posts 29 and positioning holes 312, especially during maintenance or replacement of the check valve 27 of the adapter 20. In other words, the check valve 27 is firmly installed and limited between the adapter 20 and the installation wall 311 of the seat 30 by the design of the adapter 20 to prevent backflow of cold water or hot water and further protects water sources from contamination.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A thermostatic valve set comprising:
a thermostatic valve having an operation end and a water end; the operation end being provided with a shaft which is rotating adjustable and the water end having a cold-water inlet, a hot-water inlet, a first mixed water outlet, and a second mixed water outlet; the first mixed water outlet and the second mixed water outlet having a 180-degree between them;
an adapter having an installation side and an adaption side; the adaption side being detachably connected with the water end of the thermostatic valve; the adapter including a cold-water inlet channel, a hot-water inlet channel, and a mixing-water outlet channel which respectively form a cold-water port, a hot-water port, and a mixing-water port on the adaption side; the cold-water port, the hot-water port, and the mixing-water port respectively connected and communicating with the cold-water inlet, the hot-water inlet, and the first mixed water outlet correspondingly so that the thermostatic valve and the adapter are in a first assembled state; the thermostatic valve being allowed to be rotated 180 degrees after detached from the adapter and then reassembled with the adapter so that the thermostatic valve and the adapter are in a second assembled state; in the second assembled state, the cold-water port, the hot-water port, and the mixing-water port respectively connected and communicating with the hot-water inlet, the cold-water inlet, and the second mixed water outlet correspondingly.

2. The thermostatic valve set as claimed in claim 1, wherein the thermostatic valve is either a temperature-sensing thermostatic valve or a pressure-balance thermostatic valve.

3. The thermostatic valve set as claimed in claim 1, wherein the water end of the thermostatic valve and the adaption side of the adapter are respectively provided with a first positioning member and a second positioning member; the thermostatic valve and the adapter are able to be detachably assembled and positioned with each other by the first positioning member and the second positioning member no matter in the first assembled state or the second assembled state.

4. The thermostatic valve set as claimed in claim 3, wherein the first positioning member includes two positioning grooves with a 180-degree angle therebetween while the second positioning member includes two positioning protrusions having a 180-degree angle therebetween and able to be detachably assembled and positioned with the corresponding positioning grooves.

5. The thermostatic valve set as claimed in claim 4, wherein the first positioning member further includes four locking walls disposed on two sides of the positioning grooves; the positioning protrusion includes a positioning pin and two elastic locking blocks; an outer peripheral wall of the positioning pin is able to abut against and position in an inner wall of the corresponding positioning groove circumferentially; the elastic locking block is detachably locked on and limited by the locking wall of the corresponding positioning groove.

6. The thermostatic valve set as claimed in claim 1, wherein a clipped portion is arranged at the adaption side of the adaptor for being held by tools.

7. The thermostatic valve set as claimed in claim 6, wherein the adaption side of the adapter is provided with a junction surface on which the cold-water port, the hot-water port, and the mixing-water port are formed; the clipped portion is disposed on the junction surface at a position having a 180-degree angle with respect to the mixing-water port; the clipped portion is having one protruding block projecting from the junction surface and two relief grooves recessed from the junction surface and located adjacent to two sides of the protruding block; the protruding block is able to be inserted into the first mixed water outlet located on the water end of the thermostatic valve, or the second mixed water outlet disposed opposite to the first mixed water outlet and located on the water end of the thermostatic valve.

8. The thermostatic valve set as claimed in claim 1, wherein two check valves are mounted in and limited by the cold-water inlet channel and the hot-water inlet channel of the adapter correspondingly through the installation side.

9. The thermostatic valve set as claimed in claim 1, wherein a waterproof gasket is mounted and positioned on a peripheral wall of the adapter.

10. The thermostatic valve set as claimed in claim 1, wherein the cold-water inlet channel, the hot-water inlet channel, and the mixing-water outlet channel of the adapter are respectively forming a cold-water supply outlet, a hot-water supply outlet, and a mixing-water supply outlet at the installation side; the cold-water port and the cold-water supply outlet are disposed on the same axis; the hot-water port and the hot-water supply outlet are disposed on the same axis; directions of the mixing-water port and the mixing-water supply outlet are perpendicular to each other.

11. The thermostatic valve set as claimed in claim 1, wherein two positioning posts are arranged at the installation side of the adapter for orientation and installation.

12. A valve assembly comprising: the thermostatic valve set as claimed in claim 1, a seat, and a valve cap; the seat includes a mounting groove, a cold-water supply channel, a hot-water supply channel, a first mixed water supply channel, and a second mixed water supply channel; the cold-water supply channel, the hot-water supply channel, the first mixed water supply channel, and the second mixed water supply channel are all communicating with the mounting groove;
the mounting groove is used for mounting and positioning the installation side of the adapter of the thermostatic valve set therein and provided with an installation wall on a bottom of the mounting groove; the cold-water supply channel and the hot-water supply channel are respectively provided with a cold-water intake opening and a hot-water intake opening which are located on the installation wall and respectively communicating with the cold-water inlet channel and the hot-water inlet channel of the adapter; the first mixed water supply channel and the second mixed water supply channel are communicating with the mixing-water outlet channel of the adapter at the same time; the valve cap is threaded and fastened with the seat so that the thermostatic valve set is compressed and fixed on the seat.

13. The valve assembly as claimed in claim 12, wherein the thermostatic valve is provided with a first assembly marker used for recognition of installation directions while mounting the thermostatic valve set in the mounting groove of the seat.

14. The valve assembly as claimed in claim 13, wherein the thermostatic valve further includes a valve housing from which the shaft is protruding; a cold-water side marker and a hot-water side marker are disposed on the valve housing, located at two opposite sides of the shaft and combined to form the first assembly marker; after the seat being fixed and the thermostatic valve and the adapter in the first assembled state, the thermostatic valve set is installed by the cold-water side marker and the hot-water side marker respectively being aligned with a first side and a second side of the seat; when the thermostatic valve and the adapter are in the second assembled state, the thermostatic valve set is installed by the cold-water side marker and the hot-water side marker respectively being aligned with the second side and the first side of the seat.

15. The valve assembly as claimed in claim 14, wherein the seat includes a second assembly marker which is disposed on another side of the seat opposite to one side of the seat with the mounting groove and used for recognition of installation directions while mounting and fixing the seat.

16. The valve assembly as claimed in claim 15, wherein the second assembly marker includes an upper marker, a cold-water marker, and a hot-water marker which are all arranged at the side of the seat opposite to the side of the seat with the mounting groove; when the thermostatic valve and the adapter are in the first assembled state, the cold-water side marker of the first assembly marker and the cold-water marker of the second assembly marker are on the same side as the first side of the seat; when the thermostatic valve and the adapter are in the second assembled state, the cold-water side marker of the first assembly marker and the hot-water marker of the second assembly marker are on the same side as the second side of the seat.

17. The valve assembly as claimed in claim 16, wherein the second assembly marker further includes an upper-side marker disposed on one side of the seat opposite to the side with the mounting groove.

18. The valve assembly as claimed in claim 12, wherein two positioning posts are arranged at the installation side of the adapter and the installation wall of the seat is provided with two positioning holes through which the positioning posts of the adapter are inserted and positioned for orientation and mounting of the adapter in the seat.
